(19) United States
(12) Patent Application Publication
(10) Pub. No.: US 2026/0360169 A1
(43) Pub. Date: Nov. 12, 2026

(54) Automated Creation of Modules and Hierarchy of Segmentations

(71) Applicant: Traverse3D, San Francisco, CA (US)

(72) Inventors: Huy Thanh Nguyen, San Francisco, CA (US); Shannon Gould, Oakland, CA (US); James Gardner Brown, San Francisco, CA (US)

(21) Appl. No.: 19/672,509

(22) Filed: May 8, 2026

Related U.S. Application Data
(60) Provisional application No. 63/802,967, filed on May 9, 2025.
(60) Provisional application No. 63/899,810, filed on Oct. 15, 2025.

(51) Int. Cl. G06V 20/70; G06V 10/426

(52) U.S. Cl. CPC G06V 20/70; G06V 10/426

(57) ABSTRACT

A method for generating structured content modules associated with objects in a three-dimensional space. The method includes generating a scene graph from embeddings of data inputs associated with the three-dimensional space, where the data inputs include scene information associated with objects distributed across the space and contextual information comprising relationships among the objects based on spatial, semantic, and contextual cues. The scene graph represents the objects as nodes and the relationships as edges. A content library is generated from the contextual information. Structured content modules describing an object in the three-dimensional space are generated by applying a foundational machine learning model to the scene graph. Generation includes mapping contextual information to nodes and edges, selecting contextual information relevant to the object, generating natural language content using the selected contextual information, and generating an interactive component associated with the nodes for the structured content modules.

### CROSS-REFERENCE TO RELATED APPLICATIONS

This application claims benefits of U.S. Provisional Application No. 63/802,967, filed on May 9, 2025 and U.S. Provisional Application No. 63/899,810, filed on Oct. 15, 2025, the entireties of which are incorporated herein by reference.

### BACKGROUND

### TECHNICAL FIELD

The present disclosure relates generally to systems and methods to provide an understanding and intelligence foundation for three-dimensional scenes that can be applied across multiple domains. More particularly, to generating structured content modules and scene graphs from various data inputs by integrating sensor data and contextual information about objects in a three-dimensional space.

### DESCRIPTION OF THE RELATED ART

Three-dimensional scene capture and content generation technologies have become increasingly prevalent across a range of industries, including technical training, maintenance, and education. Systems for acquiring, processing, and interacting with representations of physical environments may utilize a combination of sensors, imaging devices, and computational models to extract and organize information about objects and their relationships within a scene. In some instances, these systems can further leverage technical documentation, user annotations, and other contextual data to inform the creation of structured content modules, such as tutorials, training materials, or troubleshooting guides. As the complexity of both the scenes and the associated instructional objectives increases, there is a growing need for solutions that can efficiently generate, manage, and adapt content modules in a manner that is responsive to user needs and operational requirements.

### SUMMARY

In some aspects, the techniques described herein relate to a method for generating structured content modules associated with objects in a three-dimensional space, the method including: obtaining data inputs representing a scene, wherein the data inputs include scene information associated with the objects distributed across the three-dimensional space and contextual information including relationships among the objects based on spatial, semantic, and contextual cues present in the data inputs; processing the data inputs to produce embeddings associated with the scene; generating a scene graph from the embeddings, wherein the scene graph represents the objects within the scene as nodes and the relationships between the objects as edges; generating a content library with the contextual information from the data inputs; and generating structured content modules by using the scene graph and the content library, wherein generating the structured content modules includes: mapping the contextual information to the nodes and the edges by performing document retrieval from the nodes and the edges, wherein the document retrieval is retrieval augmented generation (RAG)-based, providing the contextual information from the document retrieval to a foundational machine learning model to generate natural language content for the structured content modules, wherein the natural language content includes sequencing instructional steps according to the contextual information, and generating, by the foundational machine learning model, an interactive component associated with the nodes for the structured content modules.

In some aspects, the techniques described herein relate to a method, wherein performing the document retrieval includes narrowing a vector search space prior to the document retrieval.

In some aspects, the techniques described herein relate to a method, wherein performing the document retrieval includes performing view-based spatial filtering to identify the nodes that are visible to perform the document retrieval according to the nodes that visible.

In some aspects, the techniques described herein relate to a method, wherein the scene information includes raw scene information that is data captured directly from a physical environment, wherein the raw scene information includes one or more of three-dimensional scans, images, video streams, or sensor measurements that describe spatial and visual properties of the three-dimensional space.

In some aspects, the techniques described herein relate to a method, wherein the contextual information includes additional input information that encompasses supplemental data sources to provide context or detail beyond the scene, wherein the additional input information includes one or more of technical documentation, user annotations, or instructional materials.

In some aspects, the techniques described herein relate to a method, wherein the contextual information includes a generation objective that is a parameter specifying an intended outcome of the structured content modules.

In some aspects, the techniques described herein relate to a method, wherein the generation objective is defined explicitly by a user.

In some aspects, the techniques described herein relate to a method, wherein the generation objective is configured to guide generation of the structured content modules to provide alignment with objectives of a user.

In some aspects, the techniques described herein relate to a method, wherein the embeddings are associated with segmentation maps of the three-dimensional space, wherein the embeddings are configured to delineate: distinct regions or objects within the scene, labeled assets that assign semantic identifiers to objects or regions, and camera viewpoints that define spatial perspectives for visualization or interaction.

In some aspects, the techniques described herein relate to a method, further including: receiving user input for interacting with the interactive component in a graphical user interface (GUI) of a client device, wherein the interactive component is associated with an object of the objects; adjusting a view displayed in the GUI to include the interactive component in a foreground of the GUI; generating a natural language response for the user input by updating the structured content modules; and generating, by the foundational machine learning model, an updated interactive component associated with the nodes for the structured content modules.

In some aspects, the techniques described herein relate to a method for generating a scene graph for a three-dimensional space, the method including: obtaining sensor data and textual data about a scene, wherein the sensor data maps the three-dimensional space, wherein the textual data includes documents associated with the three-dimensional space, wherein the scene includes a structured arrangements of objects distributed across the three-dimensional space; generating a three-dimensional representation of the scene from the sensor data and the textual data; identifying, from the sensor data, the objects in the three-dimensional representation of the scene; generating, from the three-dimensional representation of the scene, a semantic map representing the scene, wherein the semantic map includes nodes associated with the objects and edges of the nodes as relationships between the objects; processing the documents of the textual data to generate a knowledge graph describing the scene, wherein the knowledge graph describes the objects and the relationships between the objects; combining the semantic map and the knowledge graph to generate a scene graph representing the scene; generating a visualization representing the scene graph for display in an interactive interface of a graphical user interface (GUI) of a client device; and responsive to a user inputting a query in the interactive interface of the GUI to request information associated with the objects, dynamically querying the scene graph and presenting the information using the visualization.

In some aspects, the techniques described herein relate to a method, wherein combining the semantic map and the knowledge graph to generate the scene graph includes performing node-level chunking of the textual data.

In some aspects, the techniques described herein relate to a method, wherein combining the semantic map and the knowledge graph to generate the scene graph includes performing edge-attached chunking of the textual data.

In some aspects, the techniques described herein relate to a method, wherein combining the semantic map and the knowledge graph to generate the scene graph includes identifying chunks of the documents semantically related to a node of the nodes.

In some aspects, the techniques described herein relate to a method, wherein the relationships represent one or more of: a physical connection between nodes, hierarchy or containment of nodes, spatial proximity between nodes, or a functional characteristic of nodes.

In some aspects, the techniques described herein relate to a method, wherein generating the scene graph includes generating the scene graph by using a foundational machine learning model.

In some aspects, the techniques described herein relate to a method, wherein generating the visualization includes overlaying information from the scene graph on the sensor data of the scene.

In some aspects, the techniques described herein relate to a method, wherein generating the visualization includes generating renderings of the scene from the sensor data.

In some aspects, the techniques described herein relate to a method, wherein combining the semantic map and the knowledge graph includes mapping the textual data to the nodes and the edges.

In some aspects, the techniques described herein relate to a method, wherein presenting the information includes adjusting the visualization in the interactive interface according to the query.

### BRIEF DESCRIPTION OF THE DRAWINGS

The drawings are provided to aid in understanding the disclosed configurations and are not necessarily drawn to scale. Similar reference characters denote corresponding features consistently throughout the figures. Various components and features may be omitted from certain views for clarity of illustration. The drawings include:

FIG. 1 illustrates a system environment for generating content using a scene graph, according to an example configuration.

FIG. 2 illustrates a network system configured generating the scene graph and structured content modules, according to an example configuration.

FIG. 3 illustrates a workflow diagram that details the process flow for generating content modules based on a generation objective and a scene graph.

FIG. 4 illustrates an example workflow for generating and interacting with a scene graph using a visualization, according to an example configuration.

FIG. 5 is a block diagram illustrating components of an example machine for reading and executing instructions from a machine-readable medium, according to an example configuration.

### DETAILED DESCRIPTION

Below are detailed descriptions of various concepts related to, and implementations of, techniques, approaches, methods, apparatuses, and systems for simultaneous local access to live broadcast content. The various concepts introduced above and discussed in greater detail below may be implemented in any of numerous ways, as the described concepts are not limited to any particular manner of implementation. Examples of specific implementations and applications are provided primarily for illustrative purposes.

### I. INTRODUCTION

Despite advancements in three-dimensional scene understanding and automated content generation, existing approaches often encounter challenges in producing contextually relevant and hierarchically organized instructional materials. Conventional systems may lack the ability to segment and classify objects at multiple levels of granularity, or to incorporate user feedback and domain-specific objectives into the content creation process. Additionally, current methods may not provide robust mechanisms for iterative refinement, version control, or adaptive user interaction within three-dimensional environments. As a result, users may experience difficulties in locating relevant information, tailoring instructional content to specific scenarios, or efficiently troubleshooting complex systems. There remains a need for improved systems and methods that support automated and semi-automated generation of three-dimensional scene graphs and associated content modules, while enabling flexible user engagement and operational reasoning within diverse application domains.

Moreover, semantic maps derived from sensor data effectively identify and label objects within a scene but typically lack detailed contextual or factual information about the objects beyond their immediate visual attributes and spatial positions. Conversely, knowledge graphs generated from external textual sources, databases, or interviews often contain rich contextual and factual details, yet do not inherently encode direct semantic or visual relationships among objects within an actual observed environment. Accordingly, relying on either representation alone can limit the ability to comprehensively interpret scenes, particularly in applications requiring both visual understanding and contextual awareness. A method that integrates semantic maps with knowledge graphs would thus be beneficial, providing a unified representation that combines visual-semantic accuracy with extensive contextual and factual depth. Such integration would enable more thorough querying, visualization, and interaction with scene data across diverse applications.

Configurations described herein address the limitations of the conventional systems by providing systems and methods to generate structured content modules and scene graphs for objects distributed across a three-dimensional space. A network system generates a scene graph from sensor data and textual information that represents objects within the scene as nodes and the relationships between the objects as edges. To generate the content modules, the network system performs retrieval augmented generation (RAG)-based document retrieval across the scene graph to obtain the information about the nodes and edges that relate to a user query. The network system provides the retrieved information to a foundational machine learning model to generate natural language content (including, for example, sequenced instructional steps and/or interactive components) and presentation to the user.

### II. SYSTEM ENVIRONMENT

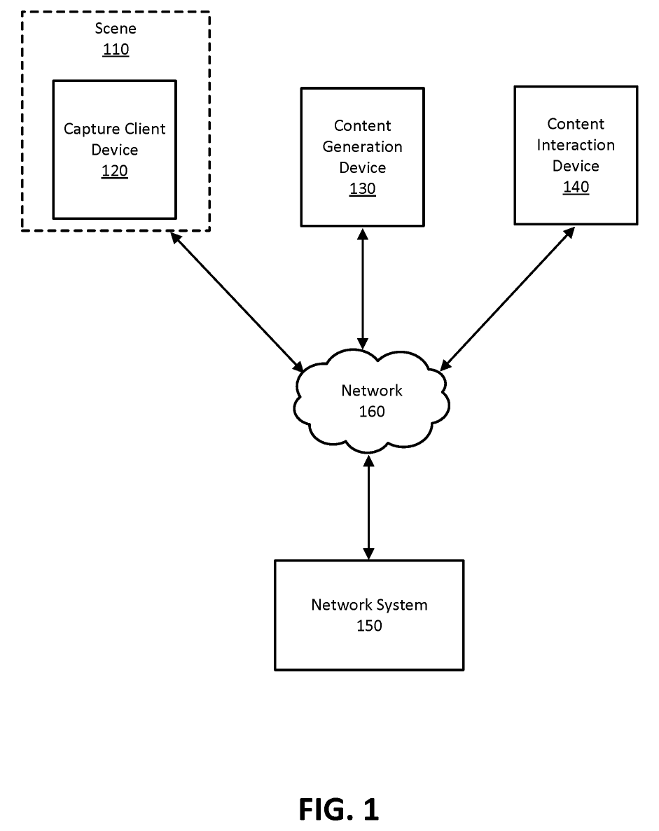

FIG. 1 illustrates a system environment 100 for generating content using a scene graph, according to an example configuration. The system environment 100 includes a scene 110, a capture client device 120, a content generation device 130, a content interaction device 140, a network system 150, and a network 160. The system environment 100 may include additional, fewer, different systems, etc. Moreover, the functionality of various elements of system environment 100 may be attributed differently than as described herein. For instance, some portion of the functionality of network system 150 may be attributed to a different, external network system (not pictured).

At a high level, the system environment 100 enables the acquisition, processing, and distribution of information derived from a physical or virtual scene, facilitating the automated and semi-automated creation of structured content modules. Components in the system environment 100 are designed to operate across distributed computing resources, leveraging network connectivity to enable communication and data exchange between devices responsible for scene capture, content generation, and user engagement. This architecture supports a modular and extensible approach to content creation, allowing for iterative refinement, user feedback, and integration of diverse data sources to produce contextually relevant and hierarchically structured content modules.

### Scene

The system environment 100 includes a scene 110. The scene 110 comprises a structured arrangement of objects distributed across a three-dimensional space. Objects in the scene 110 have distinct position and orientation relative to a global coordinate frame. Additionally, objects in the scene 110 may have semantic relationships to the scene 110 and to one another. These relationships may extend beyond a single scene, such that objects in different scenes may be semantically linked. Scenes themselves may be organized hierarchically, with larger scenes encompassing smaller, nested scenes. For example, a large scene may represent an entire laboratory space, a smaller scene may focus on a particular lab bench within that laboratory, and an even smaller scene may correspond to a specific piece of machinery located on the lab bench.

Given this example, objects such as tables, laptops, and drawers have positional and orientation information based on their location in a scene relative to a reference frame, such as a room or laboratory. There may be semantic relationships between the table and the room (centrally located), the laptop and the table (on top of), the drawers and the table (connected to), and the paper and the drawers (inside of). Contextual relationships may also be present, such as a sequence of actions for a data entry process: opening the drawer to access documents, placing the documents on the table, and using the documents with the laptop. These relationships may span across nested or related scenes, allowing the system to represent complex environments and workflows that involve multiple interconnected spaces and objects.

### Client Device

The system environment includes a capture client device 120. The capture client device 120 captures information about the scene 110. Therefore, the capture client device 120 includes one or more sensors configured to obtain measurements of a physical environment. These sensors may include image sensors, such as monocular or stereo cameras, depth-sensing devices, such as LIDAR units, time-of-flight sensors, or structured light sensors, etc. The data captured by these sensors may comprise raw pixel values, depth measurements, and other modality-specific information. Embedded within this sensor data is latent information indicative of the sensor's pose (e.g., position and orientation) at the time of capture, and information describing objects present in the scene and their spatial or contextual relationships (e.g., pixel values, object distances, etc.). The spatial relationships may be geometric and positional associations between objects in a three-dimensional scene that are represented as edges between nodes in the scene graph (such as physical connections, hierarchy/containment, proximity, and functional characteristics, e.g., “connected_to,” “part_of,” “adjacent_to,” “controls”). The capture process may occur either in a single instance or over a sequence of time intervals to gather data for dynamic or static scenes. In some instances, the capture client device 120 may be one or more client devices, each configured to capture data about the scene 110.

Thus, using our example above, the capture client device 120 capture various data measurements of the table, drawers, papers, laptop, etc. The data measurements include latent information representing the physical position and orientation of the objects, their semantic relationships, and their contextual relationships. Additionally, the capture client device 120 can capture and utilize metadata associated with both the scene acquisition process and the generation of module content. For example, during the capture phase, the capture client device 120 may record metadata such as the time and date of the scan, environmental or situational context (e.g., whether the scene represents an active construction zone or a completed environment), and user-supplied notes regarding the quality or completeness of specific areas within the scene. This captured metadata may include indications of regions that were not fully scanned, areas subject to occlusion or poor lighting, or other factors that could impact the fidelity of the resulting three-dimensional model. The system may leverage captured metadata to inform downstream processing steps, such as prioritizing segmentation and visualization of well-captured regions while de-emphasizing or flagging areas of lower quality. In certain configurations, contextual information derived from the capture metadata may supplement or override information present in technical documentation, particularly in cases where real-world conditions differ from the assumptions or descriptions found in reference materials.

### Content Generation Device

The system environment 100 includes a content generation device 130. The content generation device 130 is configured to receive captured data from the capture client device 120, either directly or through the network system 150 via the network 160, and to process this data for the automated creation of scene graphs and associated content modules. The content generation device 130 may include or access an object identification model, which analyzes multimodal inputs such as images, videos (including demonstration videos that are dynamic videos featuring the user gesturing toward the scanned 3D scene), technical documentation, and user annotations to detect and classify objects present within a scene. In some configurations, the content generation device 130 further leverages a contextual relationship engine that determines spatial, semantic, and contextual relationships among identified objects, enabling the construction of a hierarchical scene graph. The content generation device 130 may also implement automated processes for generating course modules, including sandbox modules, guided tutorials, and quizzes, based on the generated scene graph. The device 130 supports iterative feedback processes, allowing for user input to refine or modify scene graphs and content modules, facilitating a dynamic and adaptive content generation workflow. The content generation device 130 is configured to communicate with the network system 150 over the network 160 for content generation.

The content generation device 130 is further configured to define content generation objectives that guide the automated or semi-automated creation of content modules. A content generation objective is a parameter or set of parameters that specifies the context and desired outcome for the content module to be produced. The content generation device 130 may obtain the objective by querying the user directly through an interface, receiving explicit input, or by inferring the objective from user interactions, historical usage data, or contextual cues present in the captured data. For example, the content generation objective may specify that the resulting module should provide step-by-step assembly instructions for a particular mechanical component, facilitate troubleshooting for a specific subsystem, or deliver a training module focused on operational procedures. The system may utilize these objectives to tailor the structure, content, and sequencing of the generated modules, ensuring alignment with the intended instructional or operational goal.

### Content Interaction Device

The system environment 100 includes a content interaction device 140. The content interaction device 140 is configured to enable users to engage with generated content modules by providing interfaces for reviewing, editing, and consuming these modules. The content interaction device 140 may include, without limitation, a graphical user interface (GUI), a command-line interface, an application programming interface (API), a virtual reality (VR) or augmented reality (AR) setup, or a voice-only interface. In some configurations, the content interaction device 140 may support voice input and output, either as a supplement to other input modalities such as keyboard, mouse, or touch, or as a standalone mode of interaction. In many configurations, the content interaction device 140 is a GUI operating on a tablet device, where users interact with content modules primarily through touch-based inputs and may also utilize secondary voice interaction capabilities. Through the content interaction device 140, users may access content modules, annotate or modify scene graph elements, submit feedback, or approve finalized versions of courseware. Feedback mechanisms may include, for example, in-line commenting, version tracking, or direct manipulation of content elements, enabling iterative refinement of modules. The content interaction device 140 communicates with other system components via the network 160.

### Network System

The system environment 100 includes a network system 150. The network system 150 is configured to generate scene graphs and content modules within the system environment 100. To do so, the network system 150 receives multimodal information, including images, videos, technical documents, and user annotations, and processes these inputs to generate scene graphs that represent the hierarchical and semantic relationships among objects in a scene. Based on content generation objectives, the network system 150 further generates content modules, such as sandbox modules, guided tutorials, and quizzes, by leveraging the structured information contained within the scene graphs and any additional information (user feedback, technical documents, etc.). The architecture and internal modules of the network system 150 will be described in greater detail in subsequent sections.

### III. NETWORK SYSTEM

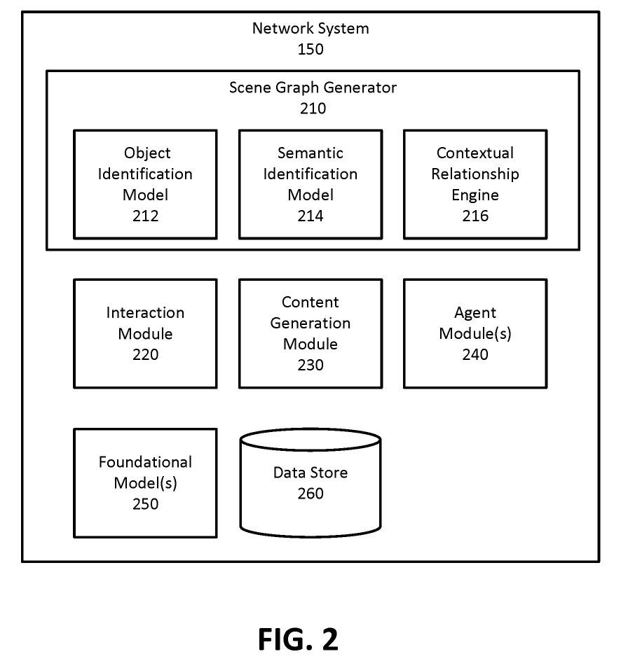

As noted above, the network system 150 inputs data from capture client device 120, content generation device 130 and content interaction device 140 to generate a scene graph and structured content modules based on that scene graph. FIG. 2 illustrates a network system 150 configured generating the scene graph and structured content modules, according to an example configuration. The network system 150 includes a scene graph generator 210, an interaction module 220, a content generation module 230, an agent module 240, one or more foundational models 250 and a data store. The network system 150 may include additional, fewer, different systems, etc. Moreover, the functionality of various elements of network system 150 may be attributed differently than as described herein. As an example, the network system 150 may include one or more type of foundational models, and the foundational models may be operated on different network systems connected via the network 160.

### Scene Graph Generator

The network system 150 includes a scene graph generator 210 configured to generate multi-dimensional scene graphs from multimodal user inputs. These user inputs may include images and/or videos of the scene 110, technical documents describing the scene or objects in the scene 110, user feedback or information about the scene, etc. The scene graph generator 210 receives these inputs and processes them using an object identification model and a contextual relationship engine. The object identification model may extract objects, features, or regions of interest from the provided data (e.g., images and videos), while the contextual relationship engine determines relationships and hierarchies among the identified objects based on spatial, semantic, and contextual cues present in the input data.

A scene graph is a data structure that represents objects within a scene as nodes and the relationships between those objects as edges. (For clarity, as described herein an “object” in the scene graph refers to the data object corresponding to its real-world object.) Each object in the scene graph describes position information (relative to a reference frame), orientation information (e.g., relative to a reference frame), a classification for the object, semantic relationships for the object (e.g., on top, inside, connected, etc.), contextual relationships for the object (e.g., step 10, related to object B, etc.), etc. For example, the scene graph may represent semantic and contextual relationships between the objects of the scene.

The purpose of the scene graph is to provide a hierarchical and semantically meaningful representation of an environment, where each node describes an object’s position, orientation, classification, semantic relationships (such as “on top of,” “inside,” or “connected to”), and contextual relationships (such as “step 10” or “related to object B”). For example, in a scene graph representing a vehicle, a node may correspond to an engine component, with child nodes representing subcomponents such as the oil dipstick or spark plugs, and edges indicating relationships such as “contained within” or “adjacent to.”

As an example, a node may represent a physical object (e.g., a laptop, table, or document), a spatial region (e.g., a drawer or room), or an abstract concept (e.g., a task or process step). Nodes may store attributes describing their associated entities, such as geometric data (e.g., position, orientation, and size), semantic labels (e.g., “tool” or “workspace”), or contextual metadata (e.g., function, usage history, or operational status).

Correspondingly, edges in the scene graph define the relationships between pairs of nodes. Edges may have different types. For example, semantic edges may represent physical relationships, such as “on top of,” “inside,” or “next to,” may describe logical or categorical / hierarchical associations, such as “is a component of” or “is similar to.” Contextual edges may describe task- or process-based relationships, such as “step A precedes step B” or “object X is used in conjunction with object Y.” The combination of nodes and edges enables the scene graph to express not only the structure and contents of the scene 110, but also the interdependencies and functional associations among the elements.

In some configurations, the nodes and edges may store information as a list of named components with segmentation data. For example, the nodes and edges may include data from a parts list (such as named components with corresponding categories), segmentation data (such as three-dimensional masks, centroids, bounding boxes, and/or the like), or no relationships (such as a part exists independently without tracking connections).

To illustrate, continuing from an example above, a scene graph may be generated in a manner that represents the desk in the room. Nodes may include, e.g., the room, the table, the laptop, drawers, etc. The node for the table, for example, stores its label, its position, its orientation, etc. Edges exist between each of the nodes that define information in the scene 110. For example, an edge between the room node and the table node may indicate that the table is inside the room, while an edge between the table and the laptop may indicate that between the room in the table may indicate that you have to open the drawers for data entry with the laptop.

Examples of scene graphs generated by the scene graph generator 210 may include, e.g., hierarchical representations of mechanical assemblies, architectural environments, or biological systems. The flexibility of the scene graph structure allows the system to accommodate a wide range of input data types and scene complexities. The scene graph generator 210 thereby enables downstream modules within the network system 150 to leverage these structured representations for further processing, such as automated content generation, interactive visualization, or adaptive user guidance.

### Scene Graph Generation

Scene graph generator 210 generates a scene graph using several steps. Initially, the network system 150 ingests the multimodal user inputs and applies the object identification model to detect and classify objects within the data. The network system determines, using a contextual relationship engine, the spatial and semantic information to infer hierarchical relationships and construct edges between nodes. The contextual and semantic relationships may use any of the multimodal inputs, and may map information between different types of inputs. The resulting scene graph may support multiple levels of segmentation and classification, enabling both broad and granular identification of objects.

The scene graph generator 210 generates a three-dimensional representation of the scene 110 from sensor data captured by capture client device 120. The captured sensor data typically comprises a set of two-dimensional (2D) image frames that depict the scene 110 from different spatial positions and orientations. The scene graph generator 210 generates the three-dimensional representation of the scene 110 by processing the 2D image frames and generating a three-dimensional scene 110. Various techniques for moving from 2D to three-dimensional are possible including structure-from-motion (SfM), simultaneous localization and mapping (SLAM), or photogrammetry. In some configurations, scene graph generator 210 may align and register individual frames or images by identifying corresponding features across multiple frames.

In an example configuration, scene graph generator 210 generates a three-dimensional representation of the scene 110 that is a splat map. The splat map comprises a set of discrete surface elements, known as splats, each associated with spatial position information and orientation data derived from the registered sensor frames. To generate the splat map, the registered sensor data is processed to estimate depth information for pixels across the aligned images, thereby establishing accurate spatial positions of scene 110 elements. Each splat is typically assigned attributes such as color, surface normal orientation, and depth derived from the sensor data. The resulting data structures provide a point-based representation of the scene 110.

The scene graph generator 210 includes an object identification model 212. The object identification model 212 identifies objects in the scene and generates a segmentation map representing those objects. To generate the segmentation map, object identification model 212 inputs the three-dimensional representation of the scene and assigns semantic labels to individual points (e.g., splats) within the scene. Techniques such as clustering algorithms (e.g., k-means, DBSCAN) or machine learning-based semantic segmentation models (e.g., convolutional neural networks or point-based neural networks) may be applied to group related three-dimensional points. Each segmented cluster corresponds to a distinct object or semantic region within the scene and is labeled accordingly. The labels may include various data describing the object such as, e.g., its position, its orientations, its label, etc. Once labeled, these object clusters may form nodes within a structured scene graph. As described below, nodes may be connected using various edges. where each represents nodes capture spatial, semantic, or functional relationships among the objects.

Notably, in some configurations, the object identification model 212 may additionally perform instance segmentation. Instance segmentation identifies different copies of an object within a semantic category. In a room with multiple laptops on a desk, the object identification model may identify the different laptops as “Laptop #1,” “Laptop #2,” etc.

The scene graph generator 210 includes a semantic identification model 214. The semantic identification model identifies semantic relationships between identified objects in the scene. In some configurations, the model may be a visual-language model that identifies semantic relationships between objects in the scene 110. Visual-language models integrate visual features extracted from sensor data with language-based representations to predict semantic interactions or relationships between identified objects. In an example, the visual-language model may include transformer-based architectures that have been pre-trained on large datasets containing paired image and textual data, enabling the model to accurately associate visual features of objects with natural language descriptions or relationships.

To provide a contextual example, scene graph generator 210 may input semantic nodes representing distinct segmented objects (e.g., obtained from object identification model 212) into semantic identification model 214 (e.g., a visual-language model). Each semantic node may include attributes such as object class, color, spatial position, and orientation derived from the processed sensor data. The visual-language model leverages these attributes to determine semantic relationships by associating object attributes with known linguistic and contextual patterns. For instance, given semantic nodes representing “laptop” and “table,” the model may infer a semantic relationship such as "laptop resting on table” based on their spatial positions and learned contextual patterns from training data. In some configurations, the scene graph generator 210 may also input the labeled sensor data into the semantic identification model 214 alongside the labeled nodes.

Scene graph generator 210 may leverage the semantic information generated by semantic identification model 214 to generate edges between nodes. That is, the semantic relationships identified by semantic identification model 214 are utilized to generate edges representing semantic relationships between nodes. These edges encode relational information such as spatial arrangement (e.g., “on,” “next to,” “under”), functional relationships (e.g., “supports,” “contains,” “holds”), or other meaningful relationships discernible from visual and contextual cues in the sensor data and nodes. For example, if semantic nodes represent objects such as “laptop,” “drawers,” and “table,” edges may indicate relationships including “laptop placed on shelf” and “drawers positioned underneath table,” forming a structured semantic representation that facilitates queries, scene understanding, and further interaction with the three-dimensional representation. In addition, a functional relationship represented by an edge may also represent a more complex relationship. For example, the relationship may represent a relationship extracted through other sources of knowledge (technical documentation, user annotations, etc.), such as, e.g., system A "powers/transfers data to/connects to" system B.

Notably, the semantic map lacks a contextual understanding of the scene. The scene graph generator 210 includes a contextual relationship engine 216. The contextual relationship engine 216 generates a data object representing contextual relationships in the scene. In an example, the data object representing contextual relationships in the scene may be a knowledge graph generated from information about the scene. The generated knowledge graph representing semantic, contextual, factual, etc. information about the scene. In some configurations, the knowledge graph may also be represented as nodes and edges, where nodes represent the objects and edges represent the contextual relationships between the objects. The knowledge graph may extend across different scenes and three-dimensional scans, capturing relationships both within and between scenes.

In an example configuration, contextual relationship engine 216 generates a knowledge graph of the scene using structured or unstructured information sources describing that scene. Sources may include textual documents, recorded interviews, reports, or databases containing descriptions and characteristics of objects and relationships relevant to the scene.

To generate the knowledge graph, contextual relationship engine 216 processes these sources through a model, such as a natural language processing (NLP) model or large language model (LLM), capable of extracting entities, attributes, and relationships. The model identifies various objects and their contextual relationships and generates a knowledge graph based on the identified objects and relationships.

The contextual relationship engine 216 may generate the knowledge graph from the information sources by performing document chunking. Document chunking is breaking data into smaller, manageable segments (“chunks”) for downstream processing, for example, to fit within LLM context windows. The network system 150 may perform document chunking on documents stored in the content library 360 to produce a plurality of document chunks. For example, the contextual relationship engine 216 may divide contextual data (such as documents associated with a course) into discrete segments at a defined level of granularity, such as page-level or section-level, and embeds each segment into a vector space for similarity-based retrieval.

The system identifies the document chunks that are relevant for a node by computing similarity scores between the chunks and the nodes. The similarity scores quantify the degree of semantic relevance between a given document chunk and the particular node. The network system 150 may compute the similarity scores using one or more similarity metrics, such as cosine similarity, dot product similarity, or other distance-based measures in the shared vector space.

The system stores the chunks of the contextual information at the nodes and/or edges. In some configurations, the contextual relationship engine 216 may attach the document chunks at nodes of the scene graph. For example, identifiers of the selected document chunks may be stored as an attribute of the particular node, such that the association between the node and its relevant document chunks persists as a property of the scene graph. The node-level chunk attachment may be a specific mechanism of chunking documents at page/section level, embedding them, and attaching top-N chunks to specific nodes via similarity scoring at build time as persistent node properties.

In other configurations, the contextual relationship engine 216 may attach the document chunks at edges of the scene graph. An edge-attached document chunk is a document chunk that describes or is relevant to the relationship between two nodes rather than to a single node. The contextual relationship engine 216 may attach document chunks to edges (relationships between parts) rather than just nodes, where the chunk explains the relationship itself. For example, a document chunk describing a hydraulic connection between a master cylinder node and a brake caliper node may be stored as a property of the edge connecting the two nodes.

The scene graph generator 210 generates a scene graph by mapping the generated knowledge graph of the scene to the semantic map of the scene. That is, scene graph generator 210 identifies objects (e.g., nodes) in the semantic map that are also present in the knowledge graph and maps the information about that object present in the knowledge graph to the semantic map. Similarly, scene graph generator 210 maps the contextual relationships present in the knowledge graph describing the scene to their corresponding nodes in the semantic map. This may include adding, modifying, etc. edges from the semantic map to include the contextual relationships between objects identified by the contextual relationship engine 216. The resulting scene graph is a node and edge structure that describes the scene, including its semantic and contextual relationships.

While described in a singular manner to this point, the scene graph generator 210 may generate one or more scene graphs. Each of the scene graphs may be generated from sensor data from one or more one or more capture client devices 120. The capture client device(s) may use a single sensor to obtain sensor data or may use multiple sensors to obtain sensor data. Additionally, the sensor data may be obtained in a single measurement or multiple measurements, and the sensor information may be obtained at the same time or at different times.

To this end, the nodes and edges in a scene graph may be connected or used between different scene graphs. Similarly, a scene graph may be used to represent multiple different sets of sensor information. For example, consider a vehicle that has multiple variants (e.g., models) and each variant has a scene graph. One variant might have the engine located in the front and another in the back. Accordingly, a scene graph for the first variant may have an edge connection can be made between the two semantically similar parts in physically different locations of the different variants.

In some configurations, the scene graph generator 210 may generate a procedure data structure. A procedure represents information extracted from the contextual data such as step-by-step instructions, troubleshooting flowcharts, or checklists. The procedure data structure may be a graph data structure that represents a traversable decision tree structure, corresponding to the procedure. Each element of the procedure may be a node of the data structure (for example, step 1 is a first node, step 2 is a second connected node, etc.). The nodes may include an entry point, a sequence of steps (connected nodes), and one or more branching conditions (as edges) that define the order and logic of traversal through the procedure data structure. For example, a procedure representing an engine startup sequence may include a first step linked to a “fuel_gauge” node of the scene graph, a second step linked to a “master_switch” node, and a third step linked to a “pressure_gauge” node.

The procedure data structure may be generated by the contextual relationship engine 216, for example, in response to parsing the contextual data. To generate the procedural data structure, the contextual relationship engine 216 processes documentation to identify procedures. The steps of the procedure may also be associated with one or more document chunks stored in the data store 260. The associated document chunks may provide supplemental information for the step, such as reference material, safety warnings, or instructional content retrieved from the technical documentation during the knowledge base build process.

In some configurations, in response to traversing the procedure data structure, the network system 150 may store session states for multi-step procedure. A session state may be data tracking progress through a procedure. The session state may include, for example, a current procedure identifier identifying the procedure being traversed, a current step identifier identifying the step at which the user is presently located within the procedure, a list of completed steps, user responses gathered during the traversal (e.g., answers to prompts or confirmations), branching conditions encountered during the traversal, and active node identifiers associated with the current step.

As an example, a user may traverse a procedure to perform diagnostics on an object in a three-dimensional space. As the user progresses through the procedure, the agent module 240 updates the session state to reflect the user’s advancement. For each step, the agent module 240 may perform one or more of the following operations: highlighting the scene graph nodes associated with the current step within the visualization presented in the GUI of the content interaction device 140, retrieving and presenting document chunks associated with the current step from the data store 260, and awaiting user input before advancing to a subsequent step.

The session state enables the network system 150 to support multi-turn interactions in which the user progresses through the procedure over multiple exchanges with the agent module 240. The agent module 240 may use the session state to maintain continuity across exchanges, to handle branching logic (e.g., if/then conditions, loops, or error conditions), and to resume the procedure from a previously saved position.

### Interaction Module

The network system includes an interaction module 220 configured to manage, e.g., user input, user requests, feedback, and the iterative refinement of both scene graphs and course content within the network system 150. The interaction module 220 may receive user input through various interfaces, including graphical user interfaces, command-line interfaces, application programming interfaces, etc. and processes these inputs to update or annotate elements of the scene graph or course modules. The interaction module 220 may also present users with system-generated statistical confidence information for specific elements of the scene graph and course content, thereby surfacing areas of low confidence for targeted user review and intervention. The interaction module 220 allows for workflows where users (e.g., via a device) may provide direct feedback, request information, or perform edits, and subsequently propagates these changes throughout the associated data structures.

To expand, the interaction module 220 enables users to provide feedback on a generated content module by surfacing editable elements and allowing users to annotate, comment, or suggest modifications. For instance, a user may review a generated scene graph and identify an incorrectly segmented object, providing feedback by marking the object for correction or supplying additional descriptive information. In another instance, a user may request information about a particular node in the scene graph, such as by querying for the associated technical documentation or operational context, and the interaction module 220 retrieves and presents the relevant data. The module also supports iterative refinement. For example, a user may iteratively adjust the segmentation of a three-dimensional asset, modify the instructional sequence of a course module, or update contextual relationships between objects, with each revision tracked and versioned by the system.

In some configurations, the interaction module 220 operates in conjunction with the data store 260 to maintain a persistent record of user inputs, feedback, and edits. The module supports version control functionality, enabling the creation of branches, rollbacks, and the comparison of different states of the scene graph and course content. For example, when a user refines a content module by altering the instructional steps or reorganizing the sequence of tasks, the interaction module 220 records these changes as a new version, allowing users to revert to previous states or merge modifications as needed. This approach ensures that all user-driven refinements are systematically integrated into the content generation workflow and that the evolution of the scene graph and course modules is fully auditable.

Additionally, user inputs, feedback, and edits may enhance the capabilities of the content interaction device. For example, annotations generated during the review or editing process may be anchored to specific three-dimensional content within the scene graph. These anchored annotations may be visualized for end users interacting with the final content module, enabling contextually relevant information, guidance, or commentary to be surfaced directly within the three-dimensional environment. This functionality may improve the clarity and utility of instructional content by providing persistent, location-specific references that remain associated with the relevant three-dimensional objects or regions throughout subsequent user interactions.

### Content Generation Module

The network system includes a content generation module 230 configured to generate structured content modules by leveraging information contained within a scene graph and other information within or provided to the network system 150. To do so, the content generation module 230 receives the scene graph (e.g., a hierarchical data structure representing objects, spatial relationships, semantic associations, and contextual links within a scene) and processes the scene graph in conjunction with additional input data (e.g., technical documents, user annotations) to synthesize course modules tailored to specific use cases. Examples of course modules generated by the content generation module 230 may include, e.g., interactive tutorials, open-ended sandbox environments, and assessment quizzes.

As an example, to generate structured content modules, the content generation module 230 implements a multi-stage process that includes information extraction, relevance determination, and structured content assembly. In a configuration, the content generation module 230 applies embedding techniques to encode both the scene graph, technical documentation, and any intermediate artifacts (e.g., embeddings, classes, etc.) into a shared vector space. The module then compares these embeddings to identify correspondences between elements of the scene graph and relevant portions of the technical documentation. For instance, the module may use similarity metrics to match nodes in the scene graph with instructional steps or troubleshooting procedures described in the documentation.

Once relevant associations are established, the content generation module 230 assembles the identified information into a structured content module format. This process may involve organizing content according to the hierarchical structure of the scene graph, sequencing instructional steps based on information found in the technical documents, and embedding interactive elements such as clickable regions or annotated viewpoints. The content generation module 230 may provide the generated content to a content interaction device 140, enabling user access, review, and engagement with the structured content modules.

The content generation module 230 is configured to generate structured content modules in accordance with a user-defined objective. As noted above, a content generation objective may be defined as a parameter or set of parameters that specifies the instructional or operational goal for the content module to be produced. The content generation module 230 may obtain the objective through explicit user input, inference from user interactions, or derivation from contextual cues present in the input data. Upon receipt of the objective, the content generation module 230 uses a foundation model (e.g., foundational model 250) to determine both the content and context of the provided objective.

The foundational model 250 processes the content and context of the user-defined objective in combination with other input data, such as scene graphs, technical documents, and user annotations, to generate a representation of a structured content module. The structured content module, when populated, is intended to fulfill the objective when consumed by, e.g., a user of a content interaction device 140. The content generation module 230 may generate a data representation of the structured content module (e.g., an embedding). This data representation may be a higher-dimensional representation that captures semantic relationships and contextual information among the various elements of the content module.

The content generation module 230 determines which information to include in the generated structured content module using a probabilistic approach. To expand, the data representation corresponding to the content module are compared to data representations for the scene graph and other input information to identify correspondences and relevant associations. This comparison enables the content generation module 230 to align instructional content with the structure and context of the underlying scene. The content generation module 230 evaluates the similarity between embeddings and assigns a likelihood score to potential content elements. The content generation module 230 then populates the content module with information from the scene graph and other input sources that meet a threshold probability of relevance to the stated objective.

In some configurations, the content generation module 230 may allow user interactions throughout the process of generating content modules. Users may interact with the content generation module (e.g., using interaction module 220) by providing explicit objectives or goals, which the module uses to guide the automated or semi-automated assembly of instructional content. The content generation module 230 may present an interface that allows users to assign specific content elements to designated modules, review automatically generated instructional steps, and modify the structure or sequencing of content as needed. In some configurations, the content generation module 230 supports user-driven editing of textual descriptions, segmentation granularity, and contextual relationships within the generated modules. The system may further support iterative refinement, allowing users to submit feedback or corrections, which the content generation module incorporates into subsequent processing cycles to produce updated content modules aligned with the specified objectives.

In some embodiments, during content generation, the content generation module 230 may cause presentation of the subject matter with multiple example configurations of content and/or three dimensional scene graphs. The user may interact with the network system 150 to provide input regarding the example configurations of content and/or three dimensional scene graph. For example, the user may provide feedback through natural language, a physical gesture (such as a thumbs up or down), and/or the like. The feedback may be used to further finetune the three dimensional content generation. For example, in response to the user providing a gesture including a thumbs up, the network system 150 may determine the gesture is approval of a presented configuration of the content.

### Example Use Cases

To continue, a contextual example of generating a structured content module is provided. The network system 150 system receives a natural language objective from a user (e.g., content generation device 130), such as “teach me how to change spark plugs on a bus engine.” Upon receipt, the content generation module 230 parses the objective using foundational model 250 to extract the desired intent and task from the natural language. The content generation module 230 determines the primary instructional goal (e.g., changing spark plugs on a bus engine) and determines the relevant context, such as the type of vehicle, the specific engine configuration, and the maintenance procedure.

The system then queries a scene graph of the bus, which includes a hierarchical representation of the bus engine and its components, to identify nodes corresponding to the spark plugs, their spatial relationships to other engine parts, and any relevant subcomponents or access points. The content generation module 230 additionally retrieves supplemental information from technical documentation, user annotations, and any additional input data associated with the identified scene graph nodes. Using embedding techniques, the module aligns content from the scene graph and documentation to the instructional steps required for spark plug replacement. The module assembles a structured content module that may include, for example, a step-by-step instructional sequence, annotated three-dimensional visualizations highlighting the location and orientation of the spark plugs, contextual safety warnings, or tool requirements. In some configurations, the system may generate and display interactive visualizations of assets, such as animations depicting a door opening or closing, or an assembly procedure occurring, to further illustrate procedural steps. Each instructional step may be linked to specific nodes in the scene graph, enabling dynamic visualization and interaction.

After assembling the content module, the system presents it to the user (e.g., by providing the content module to a content interaction device 140). The user interface may include, e.g., interactive three-dimensional views allowing the user to rotate or zoom in on the engine, clickable hotspots for additional information, and the ability to annotate or request clarification on specific steps. In this example, the network system 150 and generate content module supports iterative refinement. In this example, the content module and/ or network system 150 may surface areas of low statistical confidence in the content module (e.g., as ambiguous component identification or unclear procedural steps) and prompting the user for feedback or corrections. Any user edits or feedback are versioned and tracked by the system, enabling further automated refinement and ensuring that the instructional module remains aligned with the user’s objective and the underlying scene data.

### Agent Module

Returning now to FIG. 2, the network system includes an agent module 240. The agent module 240 is configured to enable additional artificial intelligence-driven reasoning and tool invocation within the network system 150. The agent module 240 may instantiate one or more AI agents that operate in conjunction with other system modules to support multi-step workflows and adaptive user guidance. An AI agent, as used herein, refers to a structured entity (e.g., software, instantiation, etc.) that processes user queries, plans sequences of reasoning steps, invokes available tools to interact with the three-dimensional scene graph or related content, etc. The agent module 240 integrates with modules such as the scene graph generator 210, interaction module 220, and content generation module 230, to enable coordinated AI assisted operation for content generation, user interaction, and iterative refinement processes.

The agent module 240 may generate agents operating at different scales within the network system 150. For instance, the agent module 240 may generate a world agent configured to coordinate and invoke a suite of tools and sub-agents to perform multi-step operational reasoning within the network system 150. The world agent may be an instantiation of a foundational model 250 that operates with a defined context window and is capable of managing complex workflows by invoking additional local agents or system tools as required. The world agent may access and utilize system resources, such as rendering utilities, query processors, or data retrieval modules, to fulfill specific operational objectives. For example, when the world agent determines that a particular task requires specialized processing, such as rendering a three-dimensional visualization or executing a targeted data query, it may instantiate or activate a corresponding local agent, such as a rendering agent or querying agent, to perform the required function.

In an example configuration, an agent may be configured as the sole purveyor of tasks and may be provided with a sequence of subtasks to execute in order. In this configuration, the agent sequentially processes each subtask, rather than distributing tasks among multiple agents operating in parallel with independent context windows. This approach may provide increased stability in execution, as the agent maintains a single context and deterministic workflow, reducing the non-determinism that may arise from concurrent or parallel agent operation.

Depending on the configuration of the network system 150, the agent module 240 may instantiate and manage multiple types of agents. Each agent may be configured to perform distinct operational roles within the network system 150. As noted above, agent module 240 may invoke a world agent to coordinate high-level workflows by invoking a suite of tools and delegating tasks to subordinate agents or system modules. Examples of subordinate agents may include, e.g., rendering agents that control the visual presentation of the three-dimensional scene, querying agents that retrieve or process information from the data store 260, editing agents that modify scene graph structures or content modules in response to user input or system objectives.

Each of the agents may receive user queries and, based on the context of the scene graph and/or content module, plan a sequence of reasoning steps that involve invoking one or more of these agents or tools. Functions that the agents may invoke include, without limitation, viewing the user's current perspective within the three-dimensional environment, reading and extracting relevant technical documentation, generating user interface overlays, moving or adjusting camera viewpoints, highlighting or annotating segments of the scene graph, traversing edges or nodes in the scene graph, triggering dynamic animations or visualizations, and activating user-facing UI elements such as pop-up information boxes or document viewers. In some configurations, the agent module 240 may support adaptive tool selection, where agents contextually select and invoke APIs or internal tools based on the current user query, scene context, or operational objective. The agent module 240 may further support extensibility by enabling the integration of additional agent types or tool functions as system requirements evolve.

The agent module 240 may perform data retrieval and computation from the scene graph, contextual data, and/or procedure data structure. For example, the agent module 240 may perform RAG-based document retrieval from the nodes and the edges, contextual data (such as course materials), and/or the like. RAG-based document retrieval is a process by which the agent module 240 retrieves portions of data at the nodes and/or edges that are relevant to a user query and provides the retrieved portions as context to the foundational model 250 for generating a natural language response.

The RAG may be full document retrieval or scoped document retrieval. Full document retrieval refers to a configuration in which the agent module 240 searches across document embeddings associated with a course to identify portions of contextual data relevant to the user query. In full document retrieval, the vector search space comprises an entirety of the embedded contextual data stored in the data store 260 for the course. Full document retrieval may be used, for example, when the user query is not associated with a specific node or region of the scene graph, or when the agent module 240 is unable to resolve the user query to one or more specific nodes.

The agent module 240 may perform scoped RAG to interact with the scene graph. Scoped document retrieval refers to a configuration in which the agent module 240 narrows the vector search space to a subset of the embedded contextual data prior to performing retrieval. In some configurations, performing the RAG-based document retrieval may include narrowing a vector search space prior for the RAG-based document retrieval. The system may spatially filter nodes according to a view of a user to perform the RAG-based document retrieval. For example, the system may receive an image from the user associated with the three-dimensional space. The system may identify which objects are in the image and corresponding nodes. The subset may be determined based on one or more nodes of the scene graph that are relevant to the user query. The narrowing of the vector search space may include a two-stage graph-first-then-RAG pattern rather than searching embeddings of the contextual data.

The agent module 240 performs data retrieval and computation at inference time. For example, the agent module performs RAG retrieval in response to receiving a message (such as a query) from a user. In response to receiving the message, the agent module 240 may query the data store 260 for the contextual data (such as by using pgvector).

The system provides the contextual information from the document retrieval to a foundational machine learning model to generate natural language content for the structured content modules. The natural language content includes steps of a procedure according to the contextual information. The agent module 240 may generate a response to the user query according to the contextual data. In some configurations, the agent module 240 may cause execution of an LLM to generate the response. The agent module 240 may provide relevant portions of the contextual data as context to the LLM to cause the response to be supported by the contextual data.

In some configurations, the interaction module 220 may perform view-based spatial filtering. View-based spatial filtering is using camera frustum data to identify visible nodes and automatically scope the RAG searching to the visible nodes and corresponding contextual data with respect to the objects the user is viewing.

### Foundational Model

The network system 150 includes one or more foundational models 250. The foundational model 250 provides artificial intelligence and machine learning capabilities that support key operations within the network system 150. The foundational model 250 may include, for example, transformer-based large language models, transformer-based visual language models, neural networks, decision trees, clustering algorithms, or other machine learning architectures configured to perform object identification, relationship extraction, and operational reasoning. Object identification models may include the functionality of analyzing multimodal user inputs, such as images, videos, technical documents, meeting recordings, general video recordings where the intent is not to scan, or voice recordings, to detect and classify objects present in a scene. Relationship extraction models may include the functionality of determining spatial, semantic, or contextual relationships among identified objects, and may further extract relationships from data sources such as meeting recordings, general video recordings, or voice recordings. Operational reasoning may encompass generating inferences or recommendations based on the constructed scene graph and user objectives.

### Data Store

The network system includes a data store 260. The data store 260 serves as a repository for storing various data artifacts and information generated and utilized by the network system 150 and the system environment 100. The data store 260 may store, e.g., user inputs, generated scene graphs, course modules, and historical versions of these artifacts to support version control functionality. The data store 260 interacts with modules such as the content generation module 230 and interaction module 220, providing persistent access to data required for content creation, user feedback, and iterative refinement processes. In some configurations, the data store 260 may be implemented as a relational database, object store, or other suitable storage architecture capable of supporting the data requirements of the network system 150.

### IV. EXAMPLE WORKFLOW – CONTENT GENERATION

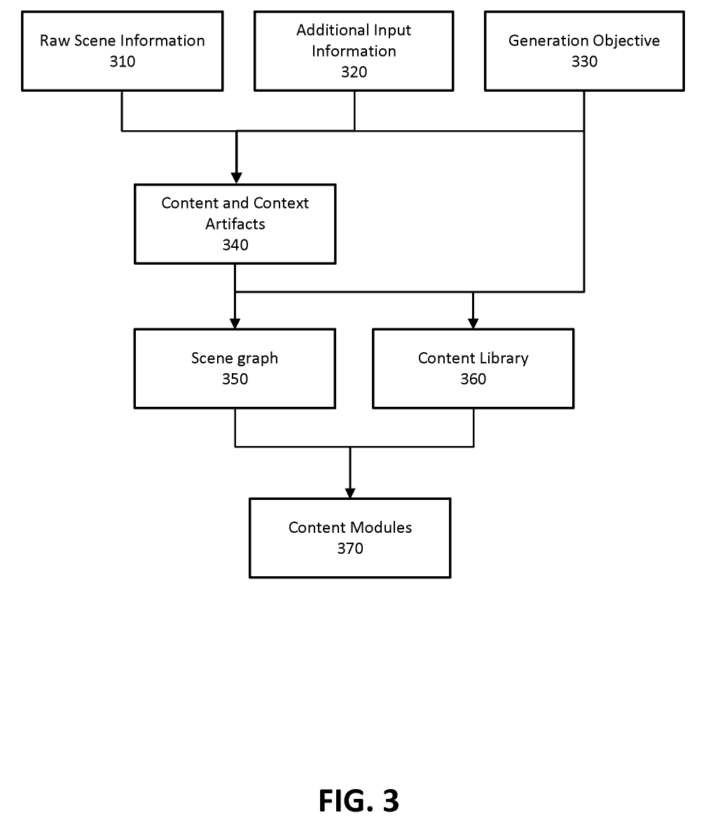

FIG. 3 illustrates a workflow diagram that details the process flow for generating content modules based on a generation objective and a scene graph. The workflow depicted in FIG. 3 comprises represents a sequence of steps in which raw scene information, supplemental input data, and a defined generation objective are processed to produce structured content modules through intermediate artifacts and data structures. The illustrated workflow may be implemented using components of the system environment 100 described herein, including the capture client device 120, content generation device 130, content interaction device 140, network system 150, and associated data stores 260.

The workflow illustrated in FIG. 3 begins with the acquisition of initial data inputs, which include raw scene information 310, additional input information 320, and a generation objective 330. Raw scene information 310 refers to data captured directly from a physical environment, and may include, e.g., three-dimensional scans, images, video streams, or sensor measurements that describe the spatial and visual properties of the environment. Additional input information 320 encompasses supplemental data sources that provide context or detail beyond the raw scene, such as technical documentation, user annotations, instructional materials, or other reference content relevant to the environment or its components. The generation objective 330 is a parameter or set of parameters that specifies the intended outcome of the content generation process, and may be defined explicitly by a user or inferred by the system from contextual cues or historical data. The generation objective 330 guides the subsequent processing and structuring of the input data to ensure that the resulting content modules align with the user’s instructional or operational goals.

Following the collection of initial data inputs, the system processes and synthesizes these inputs to produce content and context artifacts 340. Content and context artifacts 340 are intermediate data structures that encapsulate the results of analyzing and integrating the raw scene information, additional input information, and the generation objective. These artifacts may include, e.g., segmentation maps that delineate distinct regions or objects within the scene, labeled assets that assign semantic identifiers to objects or regions, and camera viewpoints that define spatial perspectives for visualization or interaction. Relationships among these artifacts, such as spatial, semantic, or contextual associations, may also be established during this stage.

The system then generates, in parallel, a scene graph 350 and a content library 360 from the content and context artifacts 340. The scene graph 350 is a hierarchical data structure that represents objects within the scene as nodes and the relationships between those objects as edges, capturing spatial, semantic, and contextual information necessary for downstream processing. The content library 360 is a repository that stores reusable content elements, instructional materials, technical documents, user annotations, and other data assets that may be referenced or incorporated into generated modules. Both the scene graph 350 and the content library 360 are populated based on the processed artifacts and inputs. To obtain the contextual information, the system may perform document chunking. The system may perform document chunking as described herein.

The system generates structured content modules 370 by leveraging both the structural information encoded in the scene graph 350 and the assets stored in the content library 360. The content modules 370 are structured outputs that may include, e.g., interactive tutorials, sandbox environments, quizzes, or other instructional formats tailored to the user’s generation objective. The system assembles each content module by mapping relevant scene graph nodes and relationships to corresponding content elements in the library, sequencing instructional steps, and embedding interactive or visual components as required.

In some configurations, the system generates the structured content modules by mapping the contextual information to the nodes and the edges of the scene graph 350. Mapping refers to a process of associating portions of the contextual information with specific nodes and/or edges of the scene graph based on a determined relevance between the contextual information and the nodes and/or edges. The system may map the contextual information to the nodes and edges by obtaining, by the scene graph data structure, contextual information for a particular node.

In response to mapping the nodes and edges between the contextual information and sensor data, the system selects contextual information in the nodes and edges of the scene graph relevant to the object of the structured content module.

The system may generate, by the foundational machine learning model, natural language content using the selected contextual information. In some configurations, the system performs retrieval augmented generation (RAG)-based document retrieval from the nodes and the edges. In some configurations, performing the RAG-based document retrieval may include narrowing a vector search space prior for the RAG-based document retrieval.

The system provides the contextual information from the document retrieval to a foundational machine learning model to generate natural language content for the structured content modules. The natural language content includes steps of a procedure according to the contextual information.

The workflow 300 may further include the system generating, by the foundational machine learning model, interactive components associated with the nodes for the structured content modules 370. The interactive components may be is a user-facing element rendered within a graphical user interface (GUI) of the content interaction device 140 that corresponds to a node of the scene graph and that is configured to receive user input and provide information, feedback, or navigation in response to the user input. Interactive components may include, without limitation, clickable hotspots overlaid on a three-dimensional visualization of the scene 110, annotated viewpoints that present contextual information when selected, highlight regions that visually distinguish a node or group of nodes within the visualization, pop-up information panels that display technical documentation or instructional content associated with a node, step indicators that denote a user's current position within a procedural workflow, and navigational controls that allow the user to rotate, zoom, or reposition the visualization relative to a node. The interactive component may be associated with an object of the objects in the scene graph.

The system may generate, by the foundational machine learning model, an updated interactive component associated with the nodes for the structured content modules 370. For example, in response to deploying the interactive components in the GUI of the client device, the system receives user input for interacting with the interactive component. The user input may include, without limitation, selecting an interactive component (e.g., tapping or clicking a digital button), hovering over an interactive component, submitting a natural language query while an interactive component is in focus, or providing a gesture-based input in a virtual reality (VR) or augmented reality (AR) environment.

The system adjusts a view displayed in the GUI to include the interactive component in a foreground of the GUI. For example, the network system 150 may reposition a viewing angle within the three-dimensional visualization of the scene 110 to center the view on the interactive component associated with the node, zoom to a level of detail appropriate for the node, and orient the view to provide a perspective of the object associated with the node, and/or the like.

The system generates a natural language response for the user input by updating the structured content modules. For example, the system may generate the natural language response and include the response in the GUI. The natural language response may instruct the user about the contextual data, for example, a next step in a procedure.

### V. EXAMPLE WORKFLOW – SCENE GRAPH GENERATION

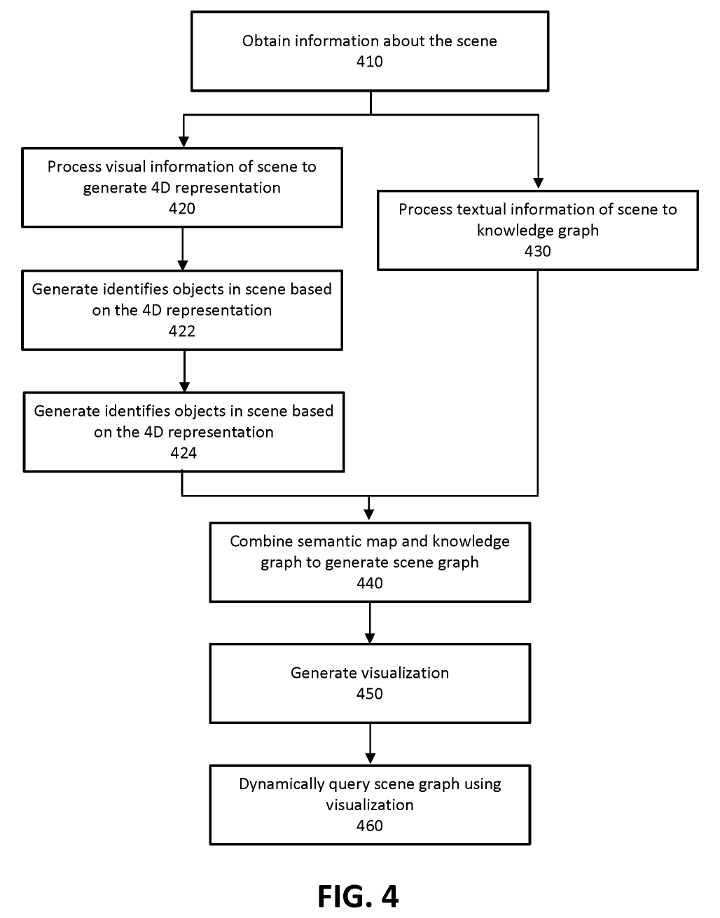

FIG. 4 illustrates an example workflow for generating and interacting with a scene graph using a visualization, according to an example configuration.

A capture client device 120 obtains 410 information about a scene 110. The information may be, e.g., sensor data such as images and/or textual data such as manuals and database entries. The sensor data may represent physical layout of the three-dimensional space. The textual data may include documents associated with the three-dimensional space. The scene may include a structured arrangements of objects distributed across the three-dimensional space.

A network system 150 accesses 420 the information and generates a three-dimensional representation of the scene 110, for example, from the sensor data and textual information. For example, network system 150 may input images representing the scene 110 and input the images into a model. The model processes the images to generate a three-dimensional representation of the scene 110. In an example, the three-dimensional representation is a splat model of the scene 110.

The network system 150 identifies 422 objects in the three-dimensional representation of the scene 110. For example, network system 150 may input the three-dimensional representation of the scene and output a labeled three-dimensional representation. In some configurations, the labeled three-dimensional representation includes nodes representing identified objects. In an example, the labeled three-dimensional representation is a three-dimensional splat map of the scene 110.

The network system 150 generates 424 a semantic map representing the scene 110. For example, network system 150 may input the sensor data (e.g., images) and/or the labeled three-dimensional representation into a model and the model may generate the semantic map. To generate the semantic map, the model identifies relationships between identified objects (e.g., physical connection between nodes, hierarchy or containment of nodes, spatial proximity between nodes, or a functional characteristic of nodes, and/or the like). In generating the semantic map, the network system 150 may append the semantic information as edges between the nodes in the semantic map.

The network system 150 processes 430 textual information describing the scene to generate a knowledge graph describing the scene. The knowledge graph includes factual and contextual information describing objects in the scene. The knowledge graph may be represented as nodes and edges.

The network system 150 combines 440 the semantic map and the knowledge graph to generate a scene graph representing the scene 110. The scene graph includes both the semantic information from the semantic map and the contextual and factual information from the knowledge graph. For example, the scene graph may include semantic and contextual relationships between the objects of the scene. The network system 150 may utilize a foundational model to generate the scene graph.

The network system 150 generates 450 a visualization representing the scene graph. The visualization may overlay information from the scene graph on sensor data of the scene or renderings of the scene generated from the sensor data. The visualization is a graphical depiction of the scene 110 that incorporates information from the scene graph, including nodes, edges, properties, and associated contextual data. The visualization may overlay information from the scene graph on sensor data of the scene 110. For example, the network system 150 may render the captured sensor data (e.g., images, three-dimensional scans, or splat maps) as a base layer and superimpose scene graph information, such as node labels, edge indicators, segmentation boundaries, or annotated regions, onto the rendered sensor data. In some configurations, the visualization may include interactive components associated with nodes of the scene graph.

The network system 150 may present the visualization in an interactive interface of a graphical user interface (GUI) of a client device. The interactive interface may allow a user to view, navigate, and manipulate the visualization. For example, the interactive interface may support user interactions such as rotating, zooming, or panning the three-dimensional rendering, selecting individual nodes or regions within the visualization, or toggling the display of scene graph information overlaid on the rendering.

The network system 150 allows a user to dynamically query 460 the scene graph and present the requested information using the visualization. In some configurations, in response to a user inputting a query in the interactive interface of the GUI to request information associated with the objects, the network system 150 dynamically queries the scene graph and presents the information using the visualization. The user may input the query using one or more input modalities supported by the content interaction device 140, such as natural language text input, voice input, touch-based selection of a node within the visualization, or gesture-based input in a VR or AR environment.

The system adjusts a view displayed in the GUI in response to the query. For example, the network system 150 may reposition a viewing angle within the three-dimensional visualization of the scene 110 to center the view on the interactive component associated with the node, zoom to a level of detail appropriate for the node, and orient the view to provide a perspective of the object associated with the node, and/or the like

### VI. ADDITIONAL CONFIGURATIONS

Additional detailed descriptions of various concepts related to the network system 150 performing agentic content generation to understand and reason over three-dimensional scenes are disclosed herein.

The system may generate a precomputed knowledge base that allows spatial reasoning across various application domains. In some configurations, user messages trigger a fresh RAG search with LLM responses grounded in documentation. The system may provide a basic view of context for where parts are in the three-dimensional scene or how the parts relate (for example, what part the user might be viewing). In other configurations, the system builds a queryable scene graph with attached documentation, enabling fast, context-aware responses at runtime. The system may provide understanding and an intelligence foundation for three-dimensional scenes that can be applied across multiple domains. For example, the system may provide virtual training (such as course instruction, procedural walkthroughs, student guidance), maintenance (such as diagnostic support, troubleshooting workflows), operations (such as real-time, or near real-time, scene understanding, decision support), general scene understanding (such as any application needing spatial + semantic intelligence), and platform/SDK (such as scene understanding API for partner integrations).

### Knowledge Base

The network system 150 may generate a knowledge base. The knowledge base is a data structure configured to store and organize information about a scene 110 in a manner that allows querying and reasoning of a three-dimensional space. The knowledge base includes information associated with the scene (such as sensor data (as described herein), geometry, spatial relationships, centroids, bounding boxes, segment identifiers, and/or the like), contextual data (for example, derived from documents and uploaded materials processed by the contextual relationship engine 216, chunked at page-level or section-level granularity and embedded into a vector space), and procedural data (such as data extracted from documentation, including decision trees, step-by-step workflows, troubleshooting flowcharts, checklists, and/or the like).

Each category of information stored in the knowledge base may be interrelated. For example, document chunks generated by the contextual relationship engine 216 may be attached to specific nodes of a scene graph based on semantic similarity scoring. Procedural data may reference both document chunks and scene graph nodes to which individual procedure steps pertain.

In some configurations, the network system 150 generates the knowledge base according to target content. The target content may include a virtual course, for which the knowledge base may include information on a per-course basis, and may further differentiate the knowledge base according to course version and/or scene. For example, a single course may encompass multiple scenes, and each scene within the course may have a separate scene graph and associated knowledge base entries.

The network system 150 stores identifications between a scene graph and the target content. For example, the network system 150 may store a course identifier and a scene identifier, such that multiple scene graphs may share a common course identifier while being distinguished by their respective scene identifiers. In this configuration, the network system 150 may maintain distinct knowledge base instances for combinations of course and scene. The combinations may include sets of nodes, edges, attached document chunks, and procedural data.

In some configurations, the knowledge base is static for a given course version. For example, in response to generating the knowledge base, the knowledge base remains fixed until a rebuild is triggered.

The network system 150 may index information stored by the knowledge base for rapid access using one or more indexing structures maintained in the data store 260. The indexing structures may include node lookup indexes to map node identifiers to properties, entity resolution indexes to map natural language names and aliases to node identifiers, and vector embedding indexes (e.g., using pgvector or a comparable vector indexing mechanism). The indexing may allow for similarity-based retrieval of document chunks.

By pre-computing and indexing the information, the knowledge base enables the network system 150 to respond to user queries without performing full-scope RAG searches across available documentation at inference time. For example, the network system 150 may perform the RAG search across scoped contextual data to retrieve a subset of information.

The network system 150 may initiate a rebuild of the knowledge base in response to one or more build triggers. Build triggers may include, without limitation, completion of a new segmentation process by the scene graph generator 210, upload or modification of documentation associated with the course, or a manual trigger initiated by an operator via the content generation device 130.

Upon detecting a build trigger, the network system 150 may regenerate the scene graph, re-chunk and re-embed the associated documentation, reattach document chunks to nodes via similarity scoring, and re-extract procedural knowledge. The resulting updated knowledge base reflects the current state of the course content and is stored in the data store 260.

The knowledge base may be queryable by a user. In some configurations, the network system 150 exposes the knowledge base through a query interface that supports a plurality of query types. The query interface may be implemented, for example, as an application programming interface (API) or an internal client class accessible by the agent module 240 and the interaction module 220.

The query interface may support node queries, such as retrieving a node by an identifier or retrieving nodes within a category. The query interface may further support relationship queries, such as retrieving nodes connected to a specified node, optionally filtered by relationship type (e.g., “connected_to,” “part_of,” or “adjacent_to”), and retrieving nodes via hierarchical edges (such as parents or other ancestor nodes). The query interface may support spatial queries, such as identifying nodes visible within a camera frustum or identifying nodes within a specified radius of a given three-dimensional point. The query interface may also support chunk queries, such as retrieving all document chunk identifiers attached to a specified node. In some configurations, the query interface may support procedure queries, such as retrieving a procedure by name or identifier and returning the associated decision tree structure with its constituent steps and linked scene graph nodes.

In some configurations, a user may query the knowledge base indirectly through natural language input provided via a graphical user interface (GUI) of the content interaction device 140. The agent module 240 or the interaction module 220 may translate the natural language input into one or more structured queries against the knowledge base and return a synthesized response to the user via the GUI.

The interaction module 220 may identify an entity with alias matching to map natural language references provided by users to specific nodes in the scene graph. To support entity identification, the knowledge base may maintain a node alias index that associates each node identifier with one or more name variants. The name variants may include a canonical name (e.g., “master_cylinder”), a human-readable display name (e.g., “Master Cylinder”), and one or more aliases (e.g., “brake master cylinder”).

At runtime, when the interaction module 220 receives a user query containing a natural language reference to a scene object (e.g., “fuel pump,” “the pump,” or a colloquial abbreviation), the interaction module 220 may perform a lookup against the node alias index to identify candidate node matches. The lookup may employ fuzzy string matching (e.g., edit distance or token-based similarity) and/or semantic matching (e.g., comparing a vector embedding of the user's natural language reference against vector embeddings of node names and aliases stored in the data store 260) to resolve ambiguous or inexact references to their corresponding node identifiers.

In cases where the natural language reference matches multiple candidate nodes (e.g., the term “pump” matches both a “fuel_pump” node and a “coolant_pump” node), the interaction module 220 may apply disambiguation techniques. For example, the interaction module 220 may use the user's current view context (e.g., which nodes are visible within the camera frustum), the user’s preceding conversation context, or may prompt the user to select among the candidate nodes via the GUI of the content interaction device 140.

Upon successful resolution, the interaction module 220 may use the resolved node identifier to scope subsequent operations. These operations may include, without limitation, retrieving attached document chunks from the data store 260, traversing graph edges from the resolved node, or highlighting the resolved node within a visualization of the scene graph presented in the GUI of the content interaction device 140.

The knowledge base allows the network system 150 to support reasoning capabilities over a three-dimensional space at runtime. The agent module 240 and/or the interaction module 220 may classify an incoming user query and cause the network system 150 to perform a corresponding reasoning capabilities based on the content and context of the query. For example, the network system 150 may perform, without limitation, view-guided understanding, procedural guidance, knowledge question and answer (Q&A), diagnostic reasoning, and geometric analysis.

### Capability 1: View-Guided Understanding

The network system 150 may provide a response according to a current view of the user and/or a user query. The user query may include image data that relates to the user’s current view of the scene 110 and/or include natural language text with spatial references such as “this,” “here,” “what I’m looking at,” and/or the like.

To provide the response, the interaction module 220 receives image data from the user query. The image data may include, for example, camera position and orientation information, a camera frustum defining the user’s current field of view, and/or an identification of a node that the user has selected or highlighted within the graphical user interface (GUI).

The interaction module 220 queries the knowledge base to identify nodes of the scene graph that are visible within the camera frustum. The visible nodes may be determined based on spatial properties stored in the knowledge base, such as centroids and bounding boxes associated with each node.

Upon identifying the visible nodes, the interaction module 220 retrieves document chunks attached to the nodes from the data store 260. In some configurations, the interaction module 220 limits the scope of the RAG search of the scene graph to the retrieved document chunks, rather than performing a full-scope search across documentation associated with the course.

The agent module 240 or the interaction module 220 may then provide the retrieved document chunks and the identified visible nodes as context to the foundational model 250. The foundational model 250 generates a natural language response that is grounded in the scoped document chunks and contextualized to the user’s current view. The natural language response is provided to the user via the GUI of the content interaction device 140.

### Capability 2: Procedural Guidance

The network system 150 may perform procedural guidance. Procedural guidance is the network system 150 guiding a user through multi-step processes, such as operational procedures, maintenance workflows, troubleshooting flowcharts, or checklists.

To perform procedural guidance, the agent module 240 matches a user query (e.g., “how do I…,” “walk me through…,” or “steps to…”) to a procedure stored in the knowledge base. The procedure may be represented as a traversable decision tree data structure comprising a sequence of steps, branching conditions, and an entry point.

Each step of the decision tree data structure may map to one or more nodes of the scene graph. The mapping of procedure steps to scene graph nodes allows the network system 150 to identify which objects in the scene 110 are relevant to each step of the decision tree data structure.

The agent module 240 traverses the decision tree data structure. For each step of the decision tree data structure, the agent module 240 may perform one or more of the following operations: highlighting the scene graph nodes associated with the current step within the visualization presented in the GUI of the content interaction device 140, retrieving and presenting document chunks associated with the current step, and awaiting user input before advancing to a subsequent step.

The agent module 240 may maintain a session state for the decision tree data structure traversal. The session state may track, for example, a current procedure identifier, a current step within the procedure, a list of completed steps, user responses gathered during the traversal, branching conditions encountered during the traversal, and active nodes associated with the current step.

### Capability 3: Knowledge Q&A

The network system 150 may perform knowledge question and answer (Q&A). Knowledge Q&A is the network system 150 answering factual questions about objects, systems, or components in the scene 110 that are not necessarily tied to the user’s current view.

To perform knowledge Q&A, the interaction module 220 resolves entity references in the user’s query to corresponding nodes in the scene graph using entity identification, as described herein. Upon resolving the entity references, the interaction module 220 retrieves the node context (e.g., properties, edges, and relationships) and the document chunks attached to the resolved nodes from the data store 260.

The interaction module 220 performs a scoped RAG search across the retrieved document chunks to identify portions of the documentation relevant to the user’s query. The scoped RAG search narrows the vector search space to the document chunks attached to the resolved nodes, rather than searching across all documentation associated with the course.

The foundational model 250 synthesizes a natural language response based on the results of the scoped RAG search, the node context, and the user’s query. The natural language response may include citations or references to the source documentation from which the information was retrieved. The natural language response is provided to the user via the GUI of the content interaction device 140.

### Capability 4: Diagnostic Reasoning

The network system 150 may generate diagnostic content. Diagnostic content describes problems, symptoms, failure states, and/or the like associated with objects in the scene 110.

To generate the diagnostic content, the interaction module 220 identifies spatial references in the user’s query (e.g., “here,” “this,” or references to a region of the scene) to one or more nodes of the scene graph. The spatial references may be identified using view context data received from the content interaction device 140, such as camera frustum data identifying visible nodes, as described herein with respect to view-guided understanding.

The interaction module 220 extracts one or more symptoms from the user’s query. The symptoms may include, for example, descriptions of observable conditions (e.g., “noise,” “leak,” “vibration”), failure states (e.g., “not starting,” “overheating”), or performance anomalies.

Upon resolving the spatial references and extracting the symptoms, the interaction module 220 performs a node lookup in the knowledge base to identify the node or nodes associated with the user’s query. The interaction module 220 then traverses the edges of the scene graph from the identified nodes to retrieve connected components. The connected components may include, for example, nodes connected by “connected_to,” “part_of,” or “controls” relationship types.

The interaction module 220 retrieves troubleshooting document chunks attached to the identified nodes and the connected component nodes from the data store 260. The troubleshooting document chunks may include, for example, chunks tagged as troubleshooting, diagnostic, or fault-related content during the knowledge base build process.

The foundational model 250 may generate one or more potential causes of the symptoms based on the identified nodes, the connected component nodes, and the retrieved troubleshooting document chunks. The foundational model 250 generates a natural language response that presents the potential causes to the user, and may include references to specific document pages, connected components, or recommended next steps. The natural language response is provided to the user via the GUI of the content interaction device 140.

### Capability 5: Geometric Analysis

The network system 150 may perform geometric analysis. Geometric analysis is a reasoning capability that enables the network system 150 to respond to user queries that require spatial analysis or view optimization based on the geometric properties of nodes in the scene graph.

To perform geometric analysis, the interaction module 220 queries the knowledge base for geometric properties associated with one or more nodes of the scene graph. The geometric properties may include, for example, centroids, bounding boxes, segment identifiers, surface normals, and spatial extents stored in the data store 260.

Based on the retrieved geometric properties, the network system 150 may compute spatial relationships such as visibility, occlusion, distances between nodes, or relative positioning of nodes within the three-dimensional space of the scene 110.

In some configurations, geometric analysis may be used to suggest an optimal camera position or viewing angle for a specified node or group of nodes. For example, the scene graph generator 210 may determine, based on a node’s centroid, bounding box, and spatial relationships to adjacent nodes, a camera position and orientation that provides a view of the specified node. The suggested camera position may be provided to the content interaction device 140 for rendering in the GUI.

In some embodiments, the network system 150 may cause execution of a vision-language model (VLM) to measure lengths and distances (such as for surveying). The network system 150 may cause execution of the VLM based on user queries from the three dimensional representation. The distances determined by the VLM may allow the network system 150 to reduce the search space for conducting the measurement. For example, the network system 150 may determine which objects are within the distance measured by the VLM, and accordingly, reduce the search space to the objects within the distance.

In some configurations, geometric analysis may be invoked in conjunction with other reasoning capabilities. For example, during procedural guidance, the network system 150 may use geometric analysis to automatically adjust the visualization displayed in the GUI of the content interaction device 140 to highlight the node associated with the current procedure step from an optimal viewing angle.

### VII. COMPUTER SYSTEM

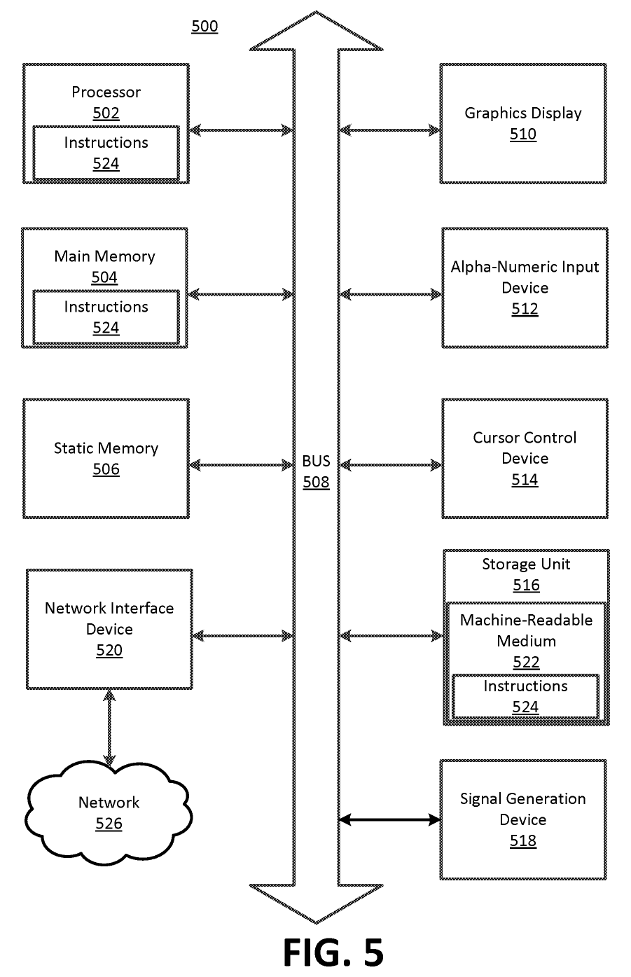

FIG. 5 is a block diagram illustrating components of an example machine for reading and executing instructions from a machine-readable medium, according to an example configuration. Specifically, FIGS. 1-4 show a diagrammatic representation of computer systems employed throughout the Specification. These systems can be in the example form of a computer system 500. The computer system 500 can be used to execute instructions 524 (e.g., program code or software) for causing the machine to perform any one or more of the methodologies (or processes) described herein. In alternative configurations, the machine operates as a standalone device or a connected (e.g., networked) device that connects to other machines. In a networked deployment, the machine may operate in the capacity of a server machine or a client machine in a system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 500 also includes a main memory 504. The computer system may include a storage unit 516. The processor 502, memory 504, and the storage unit 516 communicate via a bus 508.

In addition, the computer system 500 can include a static memory 506, a graphics display 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. For example, the instructions 524 may include the functionalities of modules of the systems described in FIG. 1. The instructions 524 may also reside, completely or at least partially, within the main memory 504 or within the processor 502 (e.g., within a processor’s cache memory) during execution thereof by the computer system 500, the main memory 504 and the processor 502 also constituting machine-readable media. The instructions 524 may be transmitted or received over a network 526 (e.g., network 160) via the network interface device 520.

While machine-readable medium 522 is shown in an example configuration to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

### VIII. ADDITIONAL CONSIDERATIONS

In the description above, for purposes of explanation, numerous specific details are set forth in order to provide a thorough understanding of the illustrated system and its operations. It will be apparent, however, to one skilled in the art that the system may be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is generally conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B is true (or present).

In addition, the use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for implementing the functionality described herein. Thus, while particular embodiments and applications have been illustrated and described, it is to be understood that the disclosed embodiments are not limited to the precise construction and components disclosed herein. Various modifications, changes, and variations, which will be apparent to those, skilled in the art, may be made in the arrangement, operation, and details of the method and apparatus disclosed herein without departing from the spirit and scope defined in the appended claims.

What is claimed is:

1. A method for generating structured content modules associated with objects in a three-dimensional space, the method comprising:
generating a scene graph from embeddings of data inputs associated with the three-dimensional space, wherein the data inputs comprise scene information associated with the objects distributed across the three-dimensional space and contextual information comprising relationships among the objects based on spatial, semantic, and contextual cues present in the data inputs, wherein the scene graph represents the objects within the three-dimensional space as nodes and the relationships between the objects as edges;
generating a content library with the contextual information from the data inputs; and
generating, by applying a foundational machine learning model to the scene graph and content library, structured content modules describing an object in the three-dimensional space, wherein generating the structured content modules comprises:
mapping the contextual information in the content library to the nodes and edges of the scene graph;
selecting contextual information in the nodes and edges of the scene graph relevant to the object of the structured content modules;
generating, by the foundational machine learning model, natural language content using the selected contextual information; and
generating an interactive component associated with the nodes for the structured content modules.

2. The method of claim 1, wherein selecting the contextual information comprises performing retrieval augmented generation (RAG) search across the scene graph to obtain the selected contextual information.

3. The method of claim 2, wherein performing the RAG search comprises narrowing a vector search space prior to the RAG search.

4. The method of claim 2, wherein performing the RAG search comprises performing view-based spatial filtering to identify the nodes that are visible to perform the RAG search according to the nodes that visible.

5. The method of claim 1, wherein the scene information comprises raw scene information that is data captured directly from a physical environment, wherein the raw scene information comprises one or more of three-dimensional scans, images, video streams, or sensor measurements that describe spatial and visual properties of the three-dimensional space.

6. The method of claim 1, wherein the contextual information comprises additional input information that encompasses supplemental data sources to provide context or detail beyond the three-dimensional space, wherein the additional input information comprises one or more of technical documentation, user annotations, or instructional materials.

7. The method of claim 1, wherein the contextual information comprises a generation objective that is a parameter specifying an intended outcome of the structured content modules.

8. The method of claim 7, wherein the generation objective is defined explicitly by a user and is configured to guide generation of the structured content modules to provide alignment with objectives of a user.

9. The method of claim 1, wherein
the embeddings are associated with segmentation maps of the three-dimensional space, wherein the embeddings are configured to delineate: distinct regions or objects within the three-dimensional space, labeled assets that assign semantic identifiers to objects or regions, and camera viewpoints that define spatial perspectives for visualization or interaction.

10. The method of claim 1, further comprising:
receiving user input for interacting with the interactive component in a graphical user interface (GUI) of a client device, wherein the interactive component is associated with an object of the objects;
adjusting a view displayed in the GUI to include the interactive component in a foreground of the GUI;
generating a natural language response for the user input by updating the structured content modules; and
generating, by the foundational machine learning model, an updated interactive component associated with the nodes for the structured content modules.

11. A method for generating a scene graph for a three-dimensional space, the method comprising:
obtaining sensor data and textual data about a scene, wherein:
the sensor data maps the three-dimensional space,
the textual data comprises documents associated with the three-dimensional space, and
the scene comprises a structured arrangement of objects distributed across the three-dimensional space;
generating a three-dimensional representation of the scene from the sensor data and the textual data;
identifying, from the sensor data, the objects in the three-dimensional representation of the scene;
generating, from the three-dimensional representation of the scene, a semantic map representing the scene, wherein the semantic map comprises nodes associated with the identified objects and edges between the nodes as relationships between the objects according to the structured arrangement of objects;
processing the documents of the textual data to generate a knowledge graph describing the scene, wherein the knowledge graph describes the identified objects and the relationships between the objects;
combining the semantic map and the knowledge graph to generate a scene graph representing the scene, wherein the scene graph represents semantic and contextual relationships between the objects of the scene;
generating a visualization representing the scene graph for display in an interactive interface of a graphical user interface (GUI) of a client device; and
responsive to a user inputting a query in the interactive interface of the GUI to request information associated with the objects, dynamically querying the scene graph and presenting the information using the visualization in the interactive interface of the GUI of the client device.

12. The method of claim 11, wherein combining the semantic map and the knowledge graph to generate the scene graph comprises performing node-level chunking of the textual data.

13. The method of claim 11, wherein combining the semantic map and the knowledge graph to generate the scene graph comprises performing edge-attached chunking of the textual data.

14. The method of claim 11, wherein combining the semantic map and the knowledge graph to generate the scene graph comprises identifying chunks of the documents semantically related to a node of the nodes.

15. The method of claim 11, wherein the relationships represent one or more of: a physical connection between nodes, hierarchy or containment of nodes, spatial proximity between nodes, or a functional characteristic of nodes.

16. The method of claim 11, wherein generating the scene graph comprises generating the scene graph by using a foundational machine learning model.

17. The method of claim 11, wherein generating the visualization comprises overlaying information from the scene graph on the sensor data of the scene.

18. The method of claim 11, wherein generating the visualization comprises generating renderings of the scene from the sensor data.

19. The method of claim 11, wherein combining the semantic map and the knowledge graph comprises mapping the textual data to the nodes and the edges.

20. The method of claim 11, wherein presenting the information comprises adjusting the visualization in the interactive interface according to the query.
